(19) United States
(12) Patent Application Publication
(10) Pub. No.: US 2008/0203356 A1
(43) Pub. Date: Aug. 28, 2008

(54) Switchable Narrow Band Reflectors Produced in a Single Curing Step

(76) Inventors: Birgitta Katarina Charlotte Kjellander, Eindhoven (NL); Dick D. Broer, Eindhoven (NL); Arie Martin De Jong, Eindhoven (NL); Leonardus Josephus Van Ijzendoorn, Eindhoven (NL)

Correspondence Address: NIXON & VANDERHYE, PC, 901 NORTH GLEBE ROAD, 11TH FLOOR, ARLINGTON, VA, 22203, US

(21) Appl. No.: 11/792,958

(22) PCT Filed: Dec. 2, 2005
(86) PCT No.: PCT/NL2005/000831

§ 371 Date: Mar. 27, 2008

(30) Foreign Application Priority Data
Dec. 2, 2004 (NL) 2004/000841

(51) Int. Cl. C09K 19/52

(52) U.S. Cl. 252/299.01

(57) ABSTRACT

The invention relates to a method to produce a multiphase polymer-based film by polymerizing monomer in the presence of a non-reactive liquid crystal and a dichroic photoinitiator whereby the polymerization is initiated by the use of linearly polarized light, the initial mixture being cholesteric before polymerization. The invention furthermore relates to the multiphase polymer-based film obtainable by the method according to the invention and products comprising such film.

The present invention relates to a novel method to produce a multiphase polymer-based film suitable for use as a switchable narrow or broad band reflector, the film obtainable by the method, and the use of the film as a switchable narrow or broad band reflector in various types of equipment.

Currently, laser holography is used to produce multiphase polymer-based films having a modulation in refractive index in depth of the film. These films can act as a switchable narrow band reflector. This is for example described in U.S. Pat. No. 4,938,568; R. L. Sutherland, Proc. SPIE, 1989, 1080, 83; R. L. Sutherland, J. Opt Soc. Am., 1991, B 8, 1516; R. T. Ingwall and T. Adams, Proc. SPIE, 1991, 1555, 279; S. Tanaka et al., Proc. SID, 1993, 24, 109; T. J. Bunning, L. V. Natarajan, V. P. Tondiglia, R. L. Sutherland, Annu. Rev. Mater. Sci. 2000, 30, 83; and M. J. Escuti, G. P. Crawford, Mat. Res. Soc. Symp. Proc. 2002, 709, 293. They can also be used as broad band reflector.

When laser holography is used on a mixture of monomers and liquid crystalline molecules, a polymer dispersed liquid crystal (PDLC) can be formed. The interference pattern of the two interfering laser beams determines the periodicity of the polymer rich and liquid crystal rich layers. This periodicity is physically limited by the wavelength of the interfering laser beams. Laser holography requires expensive and sensitive optical equipment and is limited to small area surfaces due to the diameter of the laser beams; therefore holography does not favor high throughput production processes.

Another method to produce reflection gratings is the use of chiral liquid crystals, thereby forming a cholesteric texture liquid crystal (CTLC), as for example described in EP-A-1087253; U.S. Pat. No. 5,493,430; Lu and Min-Hua, Journal of Applied Physics, 1997, 81(3), 1063-1066; D.-K. Yang, L.-C. Chien and Y. K. Fung, Liquid Crystals in Complex Geometries (ed. G. Crawford and S. Zumer), Taylor and Francis 1996, Chapter 5, page 103; and H. Yuan, Liquid Crystals in Complex Geometries (ed. G. Crawford and S. Zumer), Taylor and Francis 1996, Chapter 12, page 265.

A CTLC as such will only reflect the light of one polarisation direction coinciding with the cholesteric helix. The light of the other polarisation direction is thereby not reflected, but transmitted through the film. With this type of reflection grating only half of the light is reflected. In view of energy efficiency this is mostly not desired.

It is the object of the present invention to provide a less complex production method for multiphase films, whilst enabling efficient light management when the films are used. The inventors found that it is possible to produce a multiphase polymer-based film by polymerizing a reactive monomer in the presence of a non-reactive liquid crystal and a dichroic photoinitiator whereby the polymerization is initiated by the use of linearly polarized light, the initial mixture being cholesteric before polymerization.

The reactive monomer, the non-reactive liquid crystal and the dichroic photoinitiator form a self-organizing, cholesteric, mixture. By exposure of the cholesteric mixture to linearly polarized light, the polymerization reaction starts at depths where the dipole moment of the dichroic photoinitiator is parallel to the electric field vector of the polarized incident light. Phase separation occurs during the photo-polymerization between the formed polymer and the liquid crystalline molecules. In this way a periodicity in the index of refraction can be obtained, depending on the cholesteric pitch of the reaction mix and the propagation of the linear polarized light through the cholesteric mix. Controlling these factors, as well as the composition of the reaction mix, photochemistry and temperature, offers the possibility to choose the thickness of the individual layers in the film and tune the wavelength of reflector.

The possibility of the use of linearly polarized light, instead of interfering laser light, makes it furthermore possible to use the method over large surface areas and in continuous processes.

All known dichroic photoinitiators are suitable for the method according to the invention, for example, 1-(4-ethyl-[1,1′;4′,1″]terphenyl-4″-yl)-2-methyl-2-morpholin-4-yl-propan-1-one or 1-(4″-ethyl-2′-fluoro-[1,1′;4′, 1″]terphenyl-4-yl)-2-methyl-2-morpholin-4-yl-propan-1-one.

All non-reactive liquid crystals are suitable for use in the method according to the invention, for example as described in Flussige Kristalle in Tabellen II, 1984, edited by Demus & Zascke, VEB Deutscher Verlag fur Grundstoffindustrie. Examples of suitable preferred non-reactive liquid crystals are classes of materials that are known to those familiar in the field as cyanobiphenyls such as 4-cyano-4′-n-pentylbiphenyl, 4-cyano-4′-n-hexyloxybiphenyl or 4-cyano-4″-n-hexyl-p-terphenyl. Most often blends of liquid crystals are being used, because by blending low-melting liquid crystals can be made. A commercial mixture that contains four different cyanobiphenyls is E7 that is commercialized by Merck (Germany). In a preferred embodiment of the invention the non-reactive liquid crystal is a chiral non-reactive liquid crystal. Examples of suitable chiral non-reactive liquid crystals are

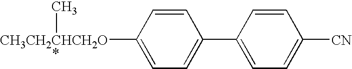

(commercialized by Merck under the name Liquid Crystal C15 (lefthanded sense of rotation) or CB15 (righthanded sense rotation)), or

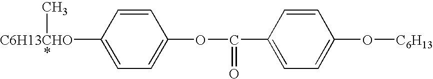

(commercialized by Merck under the name Liquid Crystal S811).

In another preferred embodiment of the invention, the non-reactive liquid crystal is a nematic non-reactive liquid crystal. Examples of suitable nematic non-reactive liquid crystals are mentioned above.

By the term “reactive monomer” is intended any compound that upon contact with reactive particles, i.e. free radicals or cationic particles, will polymerize. Preferably the monomer is a molecule comprising a reactive group of the following classes: vinyl, acrylate, methacrylate, epoxide, vinylether or thiol-ene.

The reactive monomer can have one or more reactive groups per molecule. In a preferred embodiment at least one monomer having more than one reactive group is used. This has the advantage that upon polymerization a polymer network is formed, resulting in a faster reaction and or better mechanical properties of the resulting film.

Examples of reactive monomers having at least two crosslinking groups per molecule include monomers containing (meth)acryloyl groups such as trimethylolpropane tri(meth)acrylate, pentaerythritol (meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, polybutanediol di(meth)acrylate, tripropyleneglycol di(meth)acrylate, glycerol tri(meth)acrylate, phosphoric acid mono- and di(meth)acrylates, C₇-C₂₀ alkyl di(meth)acrylates, trimethylolpropanetrioxyethyl (meth)acrylate, tris(2-hydroxyethyl)isocyanurate tri(meth)acrylate, tris(2-hydroxyethyl)isocyanurate di(meth)acrylate, pentaerythritol tri(meth)acrylate, pentaerythritol tetra(meth)acrylate, dipentaerythritol monohydroxy pentacrylate, dipentaerythritol hexacrylate, tricyclodecane diyl dimethyl di(meth)acrylate and alkoxylated versions, preferably ethoxylated and/or propoxylated, of any of the preceding monomers, and also di(meth)acrylate of a diol which is an ethylene oxide or propylene oxide adduct to bisphenol A, di(meth)acrylate of a diol which is an ethylene oxide or propylene oxide adduct to hydrogenated bisphenol A, epoxy (meth)acrylate which is a (meth)acrylate adduct to bisphenol A of diglycidyl ether, diacrylate of polyoxyalkylated bisphenol A, and triethylene glycol divinyl ether, adduct of hydroxyethyl acrylate, isophorone diisocyanate and hydroxyethyl acrylate, adduct of hydroxyethyl acrylate, toluene diisocyanate and hydroxyethyl acrylate, and amide ester acrylate.

Examples of suitable monomers having only one reactive group per molecule include monomers containing a vinyl group, such as N-vinyl pyrrolidone, N-vinyl caprolactam, vinyl imidazole, vinyl pyridine; isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, acryloyl morpholine, (meth)acrylic acid, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, caprolactone acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, tridecyl (meth)acrylate, undecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl (meth)acrylate, phenoxyethyl (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone (meth)acrylamide, beta-carboxyethyl (meth)acrylate, phthalic acid (meth)acrylate, isobutoxymethyl (meth)acrylamide, N,N-dimethyl (meth)acrylamide, t-octyl (meth)acrylamide, dimethylaminoethyl (meth)acrylate, diethylaminoethyl (meth)acrylate, butylcarbamylethyl (meth)acrylate, n-isopropyl (meth)acrylamide fluorinated (meth)acrylate, 7-amino-3,7-dimethyloctyl (meth)acrylate, N,N-diethyl (meth)acrylamide, N,N-dimethylaminopropyl (meth)acrylamide, hydroxybutyl vinyl ether, lauryl vinyl ether, cetyl vinyl ether, 2-ethylhexyl vinyl ether; and compounds represented by the following formula (I)

CH₂═C(R⁶)—COO(R⁷O)ₘ—R⁸ (I)

wherein R⁶ is a hydrogen atom or a methyl group; R⁷ is an alkylene group containing 2 to 8, preferably 2 to 5 carbon atoms; and m is an integer from 0 to 12, and preferably from 1 to 8; R⁸ is a hydrogen atom or an alkyl group containing 1 to 12, preferably 1 to 9, carbon atoms; or, R⁸ is a tetrahydrofuran group—comprising alkyl group with 4-20 carbon atoms, optionally substituted with alkyl groups with 1-2 carbon atoms; or R⁸ is a dioxane group-comprising alkyl group with 4-20 carbon atoms, optionally substituted with methyl groups; or R⁸ is an aromatic group, optionally substituted with C₁-C₁₂ alkyl group, preferably a C₈-C₉ alkyl group, and alkoxylated aliphatic monofunctional monomers, such as ethoxylated isodecyl (meth)acrylate, ethoxylated lauryl (meth)acrylate, and the like.

Oligomers suitable for use as reactive monomer are for example aromatic or aliphatic urethane acrylates or oligomers based on phenolic resins (ex. bisphenol epoxy diacrylates), and any of the above oligomers chain extended with ethoxylates. Urethane oligomers may for example be based on a polyol backbone, for example polyether polyols, polyester polyols, polycarbonate polyols, polycaprolactone polyols, acrylic polyols, and the like. These polyols may be used either individually or in combinations of two or more. There are no specific limitations to the manner of polymerization of the structural units in these polyols. Any of random polymerization, block polymerization, or graft polymerization is acceptable. Examples of suitable polyols, polyisocyanates and hydroxylgroup-containing (meth)acrylates for the formation of urethane oligomers are disclosed in WO 00/18696, which is incorporated herein by reference.

Also combinations of any of the above materials may be used. Combinations of compounds that together may result in the formation of a crosslinked phase and thus in combination are suitable to be used as the reactive monomer are for example carboxylic acids and/or carboxylic anhydrides combined with epoxies, acids combined with hydroxy compounds (for example 2-hydroxyalkylamides), amines combined with isocyanates, for example blocked isocyanate, uretdion, or carbodiimide, epoxies combined with amines or with dicyandiamides, hydrazinamides combined with isocyanates, hydroxy compounds combined with isocyanates, for example blocked isocyanate, uretdion or carbodiimide, hydroxy compounds combined with anhydrides, hydroxy compounds combined with (etherified) methylolamide (“amino-resins”), thiols combined with isocyanates, thiols combined with acrylates or other vinylic species (optionally radical initiated), acetoacetate combined with acrylates, and when cationic crosslinking is used epoxy compounds with epoxy or hydroxy compounds. Also a mixture of monomers can be used.

In another embodiment of the invention, the monomers can exist of or comprise a reactive liquid crystal. Examples of suitable reactive liquid crystals are given in ‘Photoinitiated polymerization and crosslinking of LC systems’ by D. J. Broer in ‘Radiation curing in polymer science and technology’, 1993, Vol III(12), pgn 383-493.

In yet another embodiment of the invention, the monomers can exist of or comprise a chiral liquid crystalline reactive monomer. Examples of suitable chiral liquid crystalline reactive monomers are

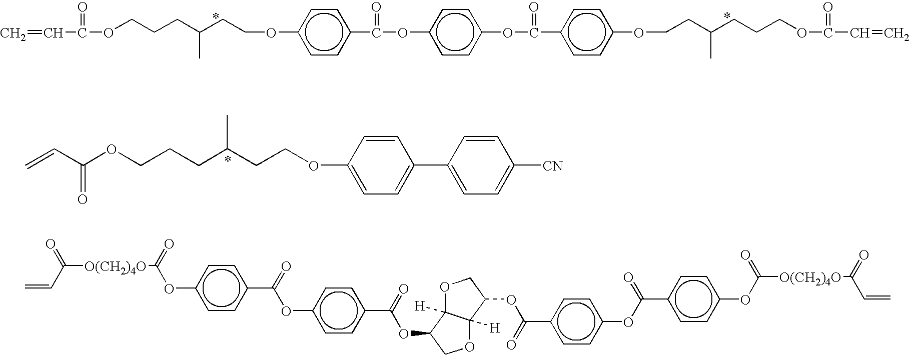

In one preferred embodiment, non-liquid crystalline monomers mixed together with chiral and nematic non-reactive liquid crystals and dichroic photo-initiator form the reaction mixture. In another preferred embodiment the chiral liquid crystal is reactive and forms the reaction mixture with non-liquid crystal monomers, nematic non-reacting liquid crystals and dichroic photo-initiator. Preferably either one of the non-reactive liquid crystal or the reactive monomer comprises the chirality. The reactive monomer or mixture of reactive monomers will form the polymer, which depending on the nature of the monomers, becomes anisotropic or isotropic. In a preferred embodiment of the invention, the resulting polymer is isotropic. This has the advantage by having a uniform refractive index, and thus not suffering from light guiding and different diffraction of the light in its different components, as is the case for an anisotropic medium.

The polymer will phase separate from the liquid crystal phase upon its formation. The phase can be distributed in all kind of ways, for example in a droplet like-way or in layers.

In a preferred embodiment of the invention, the liquid crystal phase separates from the upon polymerization formed polymer in a periodic way resulting in a stack of alternating layers of polymer and non-reactive liquid crystal, yielding a multilayered film. This also comprises a mulitlayered embodiment wherein the layer comprising the liquid crystal is not a continuous layer, for example wherein it comprises the liquid crystal embedded in a polymer layer, for example in the form of droplets of liquid crystal.

The polymer layers can be connected with each other by polymer protrusions crossing the non-reactive liquid crystal layers. Such protrusions can increase the stability and improve mechanical properties of the film. These polymer protrusions can for example be made prior to the multilayer formation, by a masked exposure with curing light (ie. UV- or visible light). If made prior to the multilayer formation additional stability of the system during production is given.

The average chiral pitch of the initial mixture controls the periodicity of the phases in the final film. The average chiral pitch of the initial mixture is preferably between 50 and 2000 nm, even more preferably between 200 and 500 nm, most preferably between 300-400 nm. The pitch can be measured by various conventional methods.

The cholesteric pitch of the initial mixture can be homogeneous throughout the mixture or non-homogeneous. In case the cholesteric pitch of the initial mixture is non-homogeneous, the layer periodicity of the final film is not uniform. This non-homogeneity of the film can be present in two directions, laterally to the surface of the film and/or in depth. In case the periodicity is laterally non-homogeneous, this results in patterning; whereby areas reflecting different wavelengths of light are formed, for example red, green and/or blue. This can be suitable for the use of the formed film in a color display, whereby the pixels can be based on such areas. In case the periodicity is non-homogeneous in depth of the layer, the reflection band is broadened. This can be suitable for the use of the formed film as broadband reflectors, sunscreens etc.

The layers of non-reactive liquid crystals are preferably chiral with a pitch smaller than that of the blend before polymerization of the monomer; even more preferably the pitch is smaller than the wavelength of the light to be reflected in the application. For example in case the light to be reflected in the application is visible light, the pitch in the layers of non-reactive liquid crystals should be smaller than the range of wavelengths of visible light. In one embodiment of the invention the non-reactive liquid crystal layers are nematic and uniaxially aligned. Uniaxial alignment can take place planar, tilted or perpendicular with respect to the layer planes, preferably perpendicular to the layer planes. In another embodiment of the invention, the non-reactive liquid crystal layers are nematic and randomly aligned.

The present invention also relates to a multiphase polymer-based film obtainable by the method(s) according to the invention. The advantages of the present invention compared to reflection gratings formed by holography are that according the method of the invention no size limitation for the multiphase films arises, nor does the method require expensive optical equipment, as is the case with holography. Furthermore, this invention allows that layer periodicity can be altered both laterally and in depth, which in a similar way is not feasible by holography.

The liquid crystal-phase can be embedded in a layer of polymer, for example in the shape of droplets or as a separate layer. Preferably, the film according to the invention is a multilayered film. In this embodiment of the invention, the film preferably comprises at least one layer of polymer and one layer of a nematic non-reactive liquid crystal, whereby the nematic non-reactive liquid crystal is capable of gaining the same refractive index as the polymer by means of an electric field. Even more preferably the nematic liquid crystal is a chiral-nematic liquid crystal. It is possible that all layers have the same thickness, or different. In another embodiment all layers of the same type have the same thickness whilst the layers of another type all have a different thickness. It is also possible that the thickness of the layers changes over the cross-section of the film.

In another embodiment of the invention the multilayered film comprises at least one layer of polymer and one layer of a nematic liquid crystal, whereby the nematic liquid crystal is oriented perpendicular to the polymer planes, and the refractive indices are matched, whereby it is capable of gaining a refractive index mismatch with the polymer by means of an electric field. Generally, the refractive indices of the liquid crystal (n_{LC}) and that of the polymer (nₚₒₗ) are mismatched once the deviation is greater than 0.005, preferably greater than 0.01, most preferably greater than 0.02.

In another embodiment of the invention the multilayered film comprises at least one layer of polymer and one layer of a nematic liquid crystal, whereby the nematic liquid crystal is oriented perpendicular to the polymer planes, and the refractive indices are mismatched, whereby it is capable of gaining refractive index matching with the polymer by means of an electric field. Generally, the refractive indices of the liquid crystal (n_{LC}) and that of the polymer (nₚₒₗ) are matched once the deviation is less than 0.02, preferably less than 0.01, most preferably less than 0.005.

The film according to the invention can be applied between transparent substrates provided with transparent electrodes.

In one embodiment of the invention, the film obtainable by the method according to the invention can be used as a switchable narrow band reflector. The application of a combination of reactive monomers and non-reactive liquid crystals allows switching of the reflector by an electric field, magnetic field, temperature, high intensity light etc. The film can also be equipped with for example photosensitive compounds.

Such narrow band reflectors can be used in any application requiring a switchable multilayer film, such as switches, displays, beam steering devices in telecommunication, sunscreens, decorative coatings, films for greenhouses and other agricultural applications.

In case the film according to the invention is used in a sunscreen, in one embodiment of the invention the film can additionally comprise light-sensitive material that changes the refractive index upon exposure with sunlight. Preferably the light-sensitive material used changes the refractive index upon exposure with sunlight as a result of transition from the liquid-crystalline state to the isotropic state.

In another embodiment of the invention, the film obtainable by the method according to the invention can be used as a broadband reflector for the same purpose as above.

The present invention is hereby illustrated by the following Examples.

The Examples are not intended to limit the invention in any way.

### Materials

Monomer 1 (Ethylene-glycol-phenyl-ether acrylate, Sigma-Aldrich, Inc.)

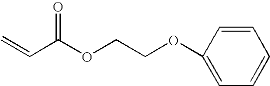

Monomer 2 (2-methyl-acrylic acid biphenyl-4-yl ester, J&W PharmLab LLC, USA)

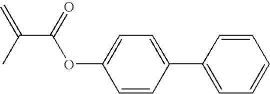

### Monomer 3 (RM275, Merck Ltd., UK)

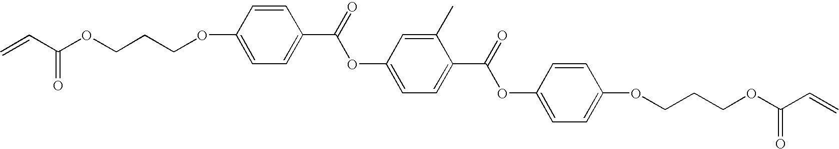

### Monomer 4 (Palicolor LC756, BASF, De)

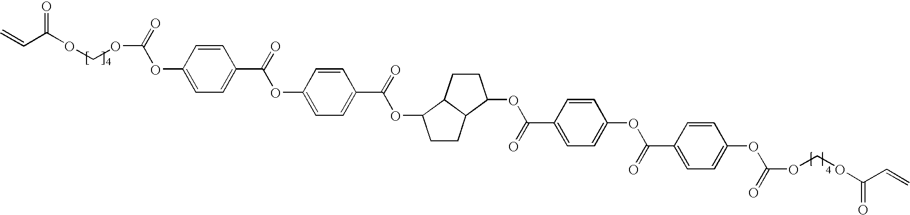

Liquid crystal 1 (K21, Merck, UK)

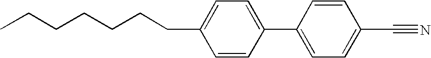

Liquid crystal 2 (K18, Merck Ltd., UK)

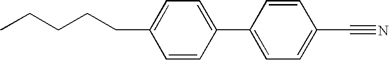

Liquid crystal 3 (CB15, Merck Ltd., UK)

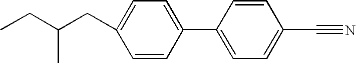

### Photoinitiator 1

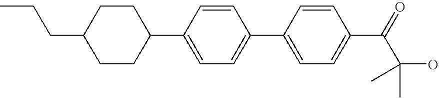

### EXAMPLE 1

A reactive mixture was composed containing the following components:

0.4 grams of monomer 1

1.0 grams of monomer 3

0.5 grams of monomer 4

7.4 grams of a liquid crystal mixture containing:
50 wt % of liquid crystal 1
50 wt % of liquid crystal 2

0.1 grams of photoinitiator 1

The mixture was liquid crystalline and has a chiral-nematic order, its transition temperature from chiral-nematic to isotropic was 12° C. The pitch of the chiral-nematic helix was 370 nm and the material reflected light of 555 nm. The intensity of the reflected light depended on the state of polarized light, i.e. it reflected right-handed and it transmitted left-handed circularly polarized light.

Glass plates, provided with indium tin oxide electrodes, were prepared by spin coating a 30 nm polyimide film from its solution in N-methyl pyrrolidone, cured at 180° C. for 90 minutes and subsequently rubbed with a polyester cloth. Two of these glass plates were mounted at a distance of 6 micrometers using glassfiber spacers and with the polyimide layers facing each other. Filling the space between the glass plates with isotropic mixture at room temperature using capillary forces formed a thin film of the reactive mixture.

After cooling to 10° C., where the film was in its chiral-nematic phase, this film is exposed to polarized UV light for 30 minutes. The polarized UV light was generated by a set up containing a fluorescent UV lamp (Philips PL10, 360 nm, 5 mW/cm²) and a polarizer (wire grid polarizer, ORIEL instruments UV linear dichroic polarizer, supplied by Fairlight BV, Rotterdam, NL).

After exposure the film was analyzed and tested on its properties. It showed periodic phase separated liquid crystal rich layers and layers of polymer. The liquid crystal was nematic. The film had a clear appearance and reflected light of a wavelength of 45 nm. The intensity of the reflected light exceeded 50% and was independent of the state of polarization of the incident light. By applying an electrical field of 60 Volts over the cross-section using the indium tin oxide electrodes, the film became fully transparent without any reflection.

### COMPARATIVE EXPERIMENT A

The same material and procedure as in Example 1 was used, but the polarizer in the irradiation set-up was absent. In this case the obtained film was scattering light rather than reflecting. Some reflection, less than 20%, was recorded at the same wavelength as the reaction mixture: 555 nm. This reflection originated from freezing in the cholesteric structure during polymerization, and it was clearly right-handedness selective. Applying a voltage over the cross-section of the film could modulate the scattering. A so-called polymer dispersed liquid crystal was now formed that was not suitable for making a switchable reflective element.

### COMPARATIVE EXPERIMENT B

The same material and procedure as in Example 1 was used, but the dichroic photoinitiator was replaced by a conventional photoinitiator (Irgacure 651, CIBA Specialty Chemicals, CH). The results were comparable to those of comparative experiment B. A scattering polymer dispersed liquid crystal was formed.

### EXAMPLE 2

A reactive mixture was composed containing the following components:

0.5 grams of monomer 2

1.0 grams of monomer 3

0.5 grams of monomer 4

8.0 grams of liquid crystal 1

0.1 grams of photoinitiator 1

The mixture was liquid crystalline and had a chiral-nematic order, its transition temperature from chiral-nematic to isotropic was 40° C. The pitch of the chiral-nematic helix was 460 nm and the material reflected light of 700 nm. The intensity of the reflected light depended on the state of polarized light, i.e. it reflected right-handed and it transmitted left-handed circularly polarized light.

Glass plates, provided with indium tin oxide electrodes, were prepared by spin coating a 30 nm polyimide film from its solution in N-methyl pyrrolidone, curing at 180° C. for 90 minutes and subsequently rubbing it with a polyester cloth. Two of these glass plates were mounted at a distance of 6 micrometers using glassfiber spacers and with the polyimide layers facing each other. Filling the space between the glass plates with isotropic mixture at an elevated temperature of 60° C. using capillary forces formed a thin film of the reactive mixture.

At the elevated temperature of 60° C. the isotropic reaction mixture was exposed by UV light through a mask for 1 min producing walls of 100 μm in a square pattern with 900×900 μm non-reacted areas between the polymerized walls. After cooling to 35° C., where the reaction mixture is chiral-nematic, this film with walls was exposed to polarized UV light for 30 minutes. The UV light was generated by a set up containing a fluorescent UV lamp (Philips PL10, 360 nm, 5 mW/cm²) and for the polarized UV-light a polarizer was used (wire grid polarizer, ORIEL instruments UV linear dichroic polarizer, supplied by Fairlight BV, Rotterdam, NL).

After exposure the film was analyzed and tested on its properties. It showed periodic phase separated liquid crystal rich layers and layers of polymer in the areas between the 100 μm polymer walls. The liquid crystal was nematic. The film had a clear appearance and reflected light of a wavelength of 650 nm. The intensity of the reflected light exceeded 50% and was independent of the state of polarization of the incident light. By applying an electrical field of 60 Volts over the cross-section using the indium tin oxide electrodes, the film became fully transparent without any reflection.

### COMPARATIVE EXPERIMENT C

The same material and procedure as in Example 2 was used, but the polarizer in the irradiation set-up was absent. In this case the obtained film was scattering light rather than reflecting, and the walls were not identified. Some reflection, less than 20%, was recorded at the same wavelength as the reaction mixture: 700 nm. This reflection originated from freezing in the cholesteric structure during polymerization, and it is clearly right-handedness selective. Applying a voltage over the cross-section of the film could modulate the scattering. A so-called polymer dispersed liquid crystal was now formed that was not suitable for use as a switchable reflective element.

### COMPARATIVE EXPERIMENT D

The same material and procedure as in Example 2 was used, but the dichroic photoinitiator was replaced by a conventional photoinitiator (Irgacure 651, CIBA Specialty Chemicals, Switzerland). The results were comparable to those of comparative experiment C. A scattering polymer dispersed liquid crystal was formed.

### EXAMPLE 3

A reactive mixture was composed containing the following components:

1.0 grams of monomer 2

2.0 grams of monomer 3

1.0 grams of liquid crystal 1

2.0 grams of liquid crystal 3

0.5 grams of photoinitiator 1

The mixture was liquid crystalline and had a chiral-nematic order, its transition temperature from chiral-nematic to isotropic was 42° C. The pitch of the chiral-nematic helix was 450 nm and the material reflected light of 675 nm. The intensity of the reflected light depended on the state of polarized light, i.e. it reflected right-handed and it transmitted left-handed circularly polarized light.

Glass plates, provided with indium tin oxide electrodes, were prepared by spin coating a 30 nm polyimide film from its solution in N-methyl pyrrolidone, curing at 180° C. for 90 minutes and subsequently rubbing it with a polyester cloth. Two of these glass plates were mounted at a distance of 6 micrometers using glassfiber spacers and with the polyimide layers facing each other. Filling the space between the glass plates an elevated temperature of 70° C. using capillary forces formed a thin film of the reactive mixture.

After cooling to 38° C., where the reaction mixture was in chiral-nematic phase, this film was exposed to polarized UV light for 30 minutes. The polarized UV light was generated by a set up containing a fluorescent UV lamp (Philips PL10, 360 nm, 5 mW/cm²) and a polarizer (wire grid polarizer, ProFlux polarizers supplied by MOXTEK, Inc., North Orem, Utah 84057).

After exposure the film was analyzed and tested on its properties. It showed periodic phase separated liquid crystal rich layers and layers of polymer. The liquid crystal was chiral-nematic with an estimated pitch of 310 nm. The film had a clear appearance and reflected light of a wavelength of 630 nm. The intensity of the reflected light exceeded 50% and was independent of the state of polarization of the incident light. By applying an electrical field of 60 Volts over the cross-section using the indium tin oxide electrodes, the film became fully transparent without any reflection.

### COMPARATIVE EXPERIMENT E

The same material and procedure as in Example 3 was used, but the polarizer in the irradiation set-up was absent. In this case the obtained film was scattering light rather than reflecting. Applying a voltage over the cross-section of the film could modulate the scattering. A so-called polymer dispersed liquid crystal was now formed that did not meet our intentions to make a switchable reflective element.

### COMPARATIVE EXPERIMENT F

The same material and procedure as in Example 3 was used, but the dichroic photoinitiator was replaced by a conventional photoinitiator (Irgacure 651, CIBA Specialty Chemicals, Switzerland). The results were comparable to those of comparative experiment E. A scattering polymer dispersed liquid crystal was formed without reflection in the visible light.

1. Method to produce a multiphase polymer-based film by polymerizing a monomer in the presence of a non-reactive liquid crystal and a dichroic photoinitiator wherein the polymerization is initiated by linearly polarized light, the initial mixture being cholesteric before polymerization.

2. Method according to claim 1, wherein the different phases obtained are stacked as layers yielding a multilayered film.

3. Method according to claim 1, wherein the reactive monomer and/or the non-reactive liquid crystal is/are chiral.

4. Method according to claim 1, wherein the reactive monomer is a reactive liquid crystal.

5. Method according to claim 1, wherein the chiral pitch of the initial mixture is between 50 and 2000 nm.

6. Method according to claim 1, wherein the chiral pitch of the initial mixture is not constant in depth and/or laterally.

7. Method according to claim 1, wherein the chiral pitch of the initial mixture is constant.

8. Method according to claim 1, wherein the polymer obtained is isotropic.

9. Method according to claim 1, wherein the resulting non-reactive liquid crystal layer is chiral-nematic with a pitch smaller than that of the mixture before polymerization of the monomer.

10. Method according to claim 1, wherein the resulting non-reactive liquid crystal layers are nematic and uniaxial aligned.

11. Method according to claim 1, wherein the resulting non-reactive liquid crystal layers are nematic and randomly aligned.

12. Method according to claim 1 wherein the resulting polymer layers are connected to each other by polymer protrusions crossing the non-reactive liquid crystal layers.

13. Multiphase polymer-based film obtainable by a method according to claim 1.

14. Multiphase polymer film according to claim 13 wherein the liquid crystal has the shape of droplets embedded in polymer.

15. Multiphase polymer-based film according to claim 13, comprising at least one layer of polymer and one layer of a (chiral-)nematic liquid crystal.

16. Multilayer polymer film according to claim 15, wherein the thickness of the layers changes over the cross-section of the film.

17. Multiphase polymer-based film according to claim 13, wherein the (chiral-)nematic liquid crystal is capable of gaining a refractive index match or mismatch with respect to the polymer by switching means.

18. Multiphase polymer film according to claim 13, wherein the film is applied between transparent substrates provided with transparent electrodes

19. Narrow band reflector, display, switch or sunscreen comprising a film according to claim 13.

20. Broadband reflector, display, switch or sunscreen, comprising a film according to claim 13.
